(19) United States
(12) Patent Application Publication
(10) Pub. No.: US 2018/0347803 A1
(43) Pub. Date: Dec. 6, 2018

(54) Lighting System for Outdoor Power Equipment

(71) Applicant: Briggs & Stratton Corporation, Wauwatosa, WI (US)

(72) Inventors: James J. Dimsey, Crivitz, WI (US); Michael R. Matonich, Waukesha, WI (US); Troy D. Tesmer, Oconomowoc, WI (US)

(21) Appl. No.: 15/997,150

(22) Filed: Jun. 4, 2018

Related U.S. Application Data
(60) Provisional application No. 62/515,583, filed on Jun. 6, 2017.

(51) Int. Cl. F21V 33/00; F21V 21/14; E01H 5/09

(52) U.S. Cl. CPC F21V 33/00; F21Y 2115/10; E01H 5/098; F21V 21/14

(57) ABSTRACT

A lighting system for use with outdoor power equipment, particularly with snowthrowers. The lighting system includes at least one downward-projecting lighting device coupled to the outdoor power equipment. The at least one downward-projecting lighting device may be configured to project light in at least a downward direction toward one or more of the following: a rear operator area, a right-side illumination area, and a left-side illumination area. The lighting system may also include at least one power source coupled to the at least one lighting device to provide electrical power to the at least one lighting device.

### CROSS-REFERENCE TO RELATED APPLICATIONS

This patent document claims priority to U.S. Provisional Patent Application No. 62/515,583, filed Jun. 6, 2017. The disclosure of the priority application is fully incorporated by reference.

### BACKGROUND

The present disclosure relates generally to outdoor power equipment such as walk-behind dual-stage and/or single-stage snowthrowers, and more particularly to lighting systems utilized for illuminating rear and/or side working areas near or adjacent to a snowthrower or other forms of outdoor power equipment.

Various types of snowthrowers (or “snowblowers”) are commonly used in regions that experience accumulating snow, largely for clearing walkways and driveways of snow both during and after accumulating snow events. Snowthrowers may be powered by electric motors or gasoline engines, and may generally be categorized as either “single-stage” or “dual-stage” snowthrowers. Single-stage snowthrowers typically include a driven impeller, which rotatably contacts the ground surface to both direct snow into a rotatable discharge chute and propel the snowthrower in a forward direction. Dual-stage snowthrowers, on the other hand, typically include a driven auger arranged slightly above the ground surface, with the auger configured to direct snow to a separate driven impeller for propulsion of the snow out of a discharge chute. Unlike a single-stage snowthrower, which relies upon the ground-contacting impeller for assisted forward motion, dual-stage snowthrowers normally include power-assisted (i.e., driven) wheels.

Due to the reduced daylight hours experienced during the winter season, as well as the importance of clearing accumulated snow from walkways and driveways either during or soon after snow events, users of snowthrowers are often tasked with operating the machines outdoors in partial or complete darkness. Such low-light (or no-light) conditions may create challenges for the user in accurately maneuvering the snowthrower to clear accumulated snow from select surfaces, while also avoiding surfaces where operation of the snowthrower may not be desired.

In order to alleviate some of the challenges experienced in operating snowthrowers in such conditions, various snowthrowers have been introduced which include one or more forward-projection lights, similar to the headlights of a vehicle. These forward-projection light(s) are configured to illuminate an area in front of the snowthrower's auger/impeller housing, thereby allowing the user to more easily see a path ahead of the snowthrower.

However, while such forward-projection lighting systems do improve the user's ability to see what is in front of the snowthrower in low-light situations, the user's visibility of the areas directly to the rear and/or sides of the snowthrower may still be compromised. Visibility in these non-forward-facing areas would be highly beneficial in determining the condition of the surface upon which the user is walking, determining any obstacles to avoid or boundaries to stay within, illuminating controls and/or components of the snowthrower, etc.

### SUMMARY

In accordance with an aspect of the disclosure, a lighting system for outdoor power equipment is disclosed. The lighting system may include at least one downward-projecting lighting device coupled to the outdoor power equipment, with the at least one downward-projecting lighting device configured to project light in at least a downward direction toward a rear operator area, a right-side working area, and/or a left-side working area. The lighting system may also include at least one power source coupled to the at least one lighting device to provide electrical power to the at least one lighting device.

In accordance with another aspect of the disclosure, a snowthrower is disclosed. The snowthrower includes a frame, an operator interface coupled to the frame, a power device coupled to the frame, and a rotatable tool at least partially surrounded by a rotatable tool housing, the rotatable tool operably coupled to the power device and configured to direct snow from a ground surface to a rotatable chute extending from the rotatable tool housing, wherein the rotatable chute is rotatable relative to the rotatable tool housing and configured to discharge snow from the snowthrower. The snowthrower also includes at least one lighting device coupled to the snowthrower, wherein the at least one lighting device is configured to project light toward a rear operator area, wherein the rear operator area comprises at least one of an area on the ground surface located behind the frame, an area below the operator interface, and an area on the ground surface where a user is standing when operating the snowthrower.

According to another aspect of the disclosure, a snowthrower is disclosed, with the snowthrower including a frame, a pair of drive wheels operably coupled to the frame, and an operator interface coupled to the frame, the operator interface including at least one hand grip and a control panel. The snowthrower also includes a rotatable tool at least partially surrounded by a rotatable tool housing, the rotatable tool configured to direct snow from a ground surface to a rotatable chute, and at least one lighting device coupled to an underside surface of one of the frame and the operator interface, wherein the at least one lighting device is configured to project light toward a rear operator area, wherein the rear operator area comprises an area on the ground surface located to the rear of the frame and the pair of drive wheels.

### BRIEF DESCRIPTION OF THE DRAWINGS

FIG. 1 is a front perspective view of a dual-stage snowthrower in accordance with an aspect of the disclosure;

FIG. 2 is rear view of the dual-stage snowthrower illustrated in FIG. 1;

FIG. 3 is a top view of the dual-stage snowthrower illustrated in FIG. 1;

FIG. 4 is a top view of a dual-stage snowthrower in accordance with another aspect of the disclosure;

FIG. 5 is a top view of a dual-stage snowthrower in accordance with another aspect of the disclosure;

FIG. 6 is a front perspective view of a single-stage snowthrower in accordance with another aspect of the disclosure;

FIG. 7 is a front perspective view of a dual-stage snowthrower in accordance with another aspect of the disclosure; and

FIG. 8 is a rear perspective view of a walk-behind litter vacuum in accordance with another aspect of the disclosure.

### DETAILED DESCRIPTION

The following description is made for the purpose of illustrating the general principles of the present system and method and is not meant to limit the inventive concepts claimed in this document. Further, particular features described in this document can be used in combination with other described features in each of the various possible combinations and permutations.

Unless otherwise specifically defined in this document, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to”. Additionally, use the term “couple”, “coupled”, or “coupled to” may imply that two or more elements may be directly connected or may be indirectly coupled through one or more intervening elements.

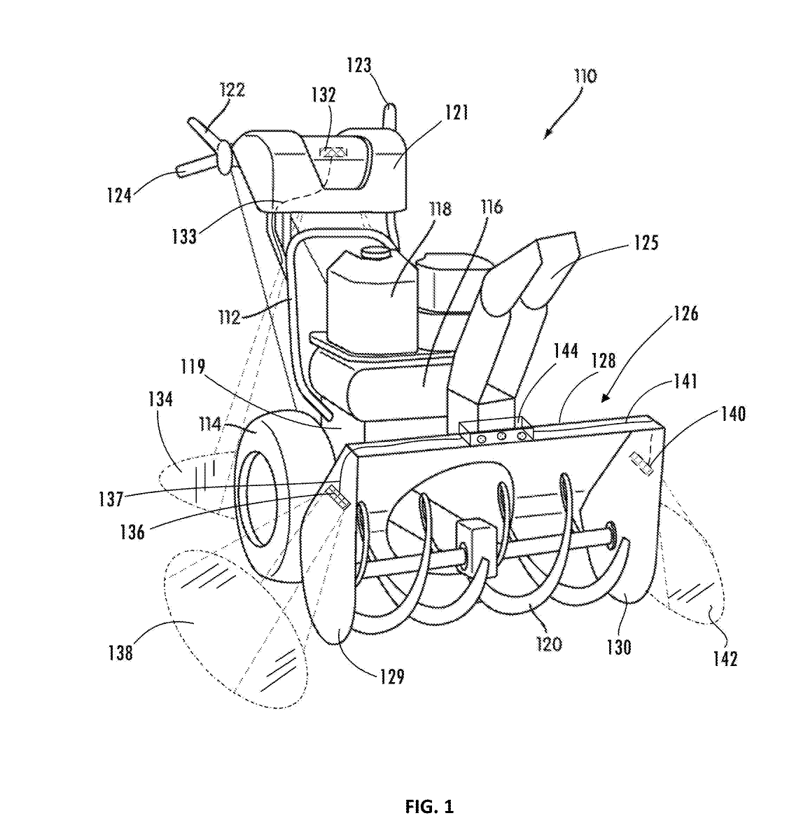

Referring to FIGS. 1-3, outdoor power equipment in the form of a dual-stage snowthrower 110 is shown. Snowthrower 110 comprises a control frame 112, a pair of drive wheels 114, an engine 116, and a fuel tank 118. Engine 116 is a power device illustrated as an internal combustion engine coupled to fuel tank 118. However, in alternative embodiments, engine 116 may be replaced by any other suitable powerhead or power device, such one or more electric motors. Additionally, while a snowthrower is illustrated, it is to be understood that the features of the present disclosure are not limited to use on snowthrowers and may be applicable to other types of outdoor power equipment, such as walk-behind lawnmowers, ride-on lawnmowers, aerators, blowers, vacuums, tillers, etc.

Engine 116 and fuel tank 118 are supported on a motor box 119, which also may be configured to support drive wheels 114 via an axle. Drive wheels 114 may be selectively driven by any appropriate transmission interface between the axle and a power take-off (PTO) of engine 116, which is generally housed within motor box 119. The speed and/or direction of drive may be selected by a user via a control lever 150 located at or near a control panel 121 on control frame 112. When a desired speed and/or direction of drive is selected by the user, a drive engagement lever 122 located adjacent to at least one hand grip 124 may be clasped or otherwise operated so as to initiate powered drive of the wheels 114.

Also coupled at an appropriate interface with the PTO of engine 116 is a rotatable tool in the form of a rotatable auger 120 housed within a rotatable tool housing, i.e., an auger housing 126. Rotatable auger 120 may be configured to collect snow, ice, or other substances from the ground surface into the auger housing 126 for directed expulsion through a selectively rotatable chute 125. While not shown in FIGS. 1-3, rotatable auger 120 may direct the snow or other substances to a separate, powered impeller located between the auger 120 and chute 125, allowing for increased volume and speed of discharge. Similar to drive engagement lever 122, an auger engagement lever 123 may be located adjacent to another, opposite hand grip 124 for selective operation of the auger 120.

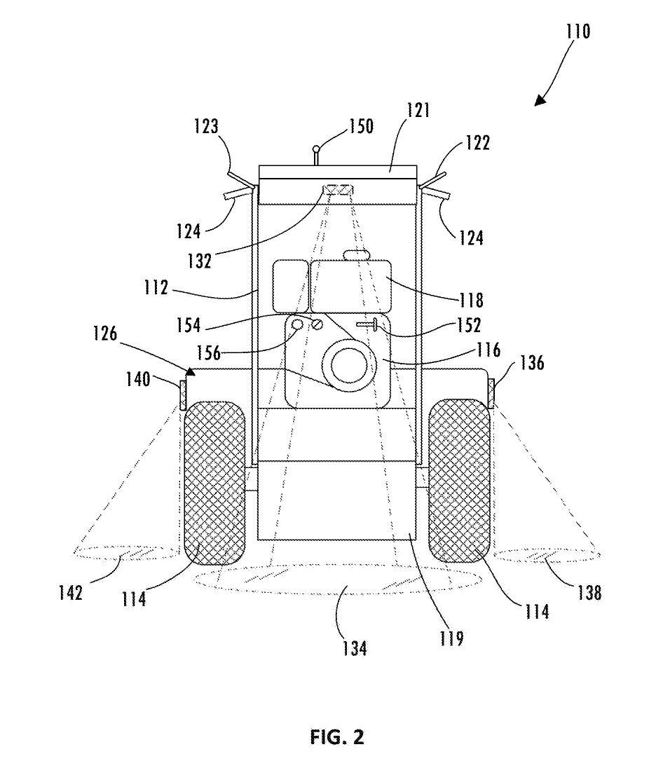

As illustrated in FIG. 2, control panel 121 may include at least one control mechanism accessible by the user, such as control lever 150. Control panel 121 may also include other control mechanisms, such as chute rotation control(s), engine starting control(s), etc. Alternatively, snowthrower 110 may not include a full control panel 121 spanning control frame 112, but may instead only include various control mechanisms mounted directly upon control frame 112.

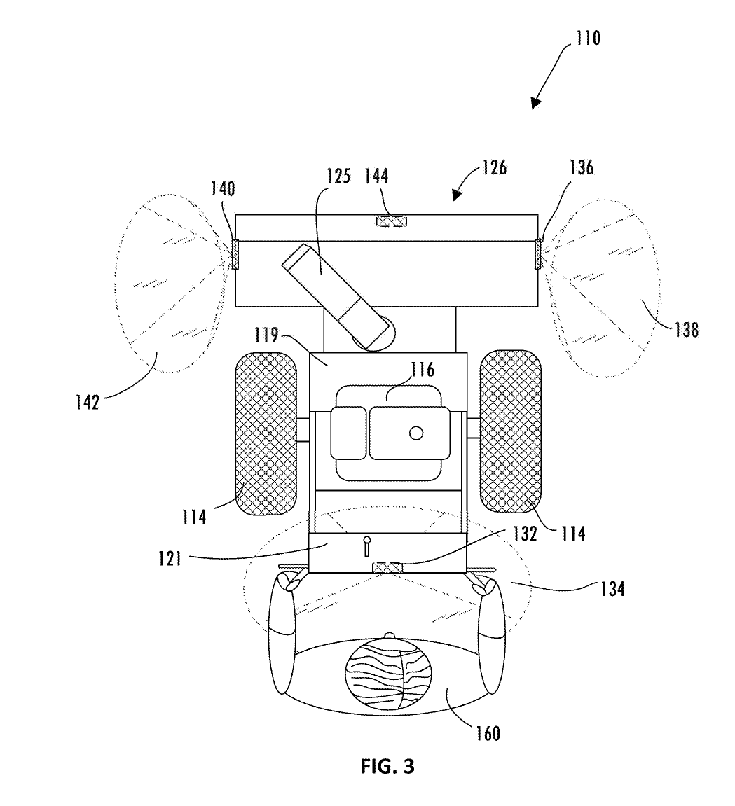

Referring still to FIGS. 1-3, snowthrower 110 includes one or more downwardly-projecting lighting devices for illuminating the ground or other work surfaces at various locations around the periphery of snowthrower 110. Specifically, at least one rear lighting device 132 may be positioned at or near the rear of snowthrower 110 for at least partial downward projection of light toward a rear operator area 134, which is an area on the ground and/or other surfaces located at least one of below the control panel 121, to the rear of the control frame 112 and/or the drive wheels 114, and to an area upon which a user stands when operating the snowthrower 110. For example, as is shown in FIG. 3, rear operator area 134 faces toward the position where a user 160 will stand/walk when operating the snowthrower 110 under typical operating conditions. Accordingly, rear lighting device(s) 132 may be configured to illuminate the ground or other working surface at or near the location of the feet of user 160, thereby allowing the user 160 to better view the surface conditions over which the snowthrower 110 is traveling. Alternatively and/or additionally, the at least one rear lighting device 132 may be configured to project light to areas outside of the rear operator area 134, including forward, rearward, and/or to the lateral sides of rear operator area 134, and the at least one rear lighting device 132 may not be limited to only the downward projection of light. Furthermore, while FIG. 3 illustrates rear operator area 134 as extending at least to the position at which user 160 stands during operation, it is to be understood that rear operator area 134 may not extend fully to the user 160, but instead may be limited to an area extending from, e.g., the rear of drive wheels 114 to a location directly below control panel 121.

In addition to illuminating the ground or other working surface behind drive wheels 114, in some embodiments, rear lighting device(s) 132 may also be configured to illuminate at least a rear portion of the motor box 119 and/or at least a rear portion of engine 116. Accordingly, in low-light environments, rear lighting device(s) 132 may allow the user 160 to see, for example, various controls located on engine 116. As illustrated in FIG. 2, engine 116 may include a variety of engine control devices, such as a throttle control lever 152, a choke control knob 154, a prime bulb 156, and/or other related controls. Operation and/or adjustment of these engine control devices may be needed prior to starting the engine or during operation of the engine. If rear lighting device(s) 132 is configured to illuminate at least a rear portion of engine 116, the user's ability to decipher and/or operate such engine control devices in low-light environments may be improved. While the rear lighting device(s) 132 is described as a downwardly-projecting lighting device, it is to be understood that rear lighting device(s) 132 may also project light forward, rearward, and/or laterally to one or both sides of the snowthrower 110, and rear operator area 134 may extend across an area larger or smaller than that which is shown in FIGS. 1-3.

In accordance with an embodiment of the disclosure, the rear lighting device(s) 132 may be mounted at or near an underside surface of control panel 121 such that light emitted from rear lighting device(s) 132 is only directed substantially downward and, thus, does not interfere with the user's forward vision. Such a mounting configuration also maintains the rear lighting device(s) 132 upon and/or within a substantially protected and inconspicuous portion of snowthrower 110. Alternatively, in some embodiments, a portion of light emitted by rear lighting device(s) 132 may be directed substantially upward and/or laterally outward so as to illuminate one or more indicators on control panel 121. For example, indicators for drive direction and/or speed (i.e., “F” for forward, “R” for rear, “1” for slow, etc.) may be cut out of control panel 121 or otherwise made to be transparent, thereby allowing light emitted by rear lighting device(s) 132 to illuminate the indicators. In such a configuration, rear lighting device(s) 132 may simultaneously act to illuminate the work surface to the rear of snowthrower 110 and various indicators on the control panel 121.

Alternatively and/or additionally, in accordance with another embodiment, rear lighting device(s) 132 may be mounted elsewhere on snowthrower 110. For example, while not shown in FIGS. 1-3, rear lighting device(s) 132 may be mounted on a rear and/or bottom portion of motor box 119 so as to illuminate rear operator area 134 and/or rear portions of the snowthrower 110. In another alternative configuration, rear lighting device(s) 132 may be mounted at any location in the vicinity control frame 112, such as, e.g., along existing cross-brackets extending between respective arms of the control frame 112.

In addition to (or in lieu of) rear lighting device(s) 132, snowthrower 110 may further include at least one right-side lighting device 136 and/or at least one left side lighting device 140. Similar to rear lighting device(s) 132, right-side lighting device(s) 136 and left-side lighting device(s) 140 may be configured for substantially downward projection of light toward respective right-side illumination area 138 and left-side illumination area 142. Alternatively and/or additionally, right-side lighting device(s) 136 and/or left side lighting device(s) 140 may be configured to project light outward and sideways away from the respective sides of auger housing 126, forward relative to the auger housing 126, and/or rearward relative to the auger housing 126. The right-side illumination area 138 is an area that includes a working surface substantially adjacent to a right side of auger housing 126, and may also extend a given distance forward, behind, and laterally relative to the auger housing 126. For example, in one embodiment, the right-side illumination area 138 may extend from a location aligned with the front of the auger housing 126 to a location aligned with the drive wheels 114 Similarly, left-side illumination area 142 is an area that includes an area of a working surface substantially adjacent to a left side of auger housing 126, and may also extend a given distance forward, behind, and laterally relative to auger housing 126, similar to right-side illumination area 138 described above. However, it is to be understood that both right-side illumination area 138 and left-side illumination area 142 may extend across areas larger or smaller than those described above. With such configurations, right-side lighting device(s) 136 and/or left-side lighting device(s) 140 may enable the user to better see the work area and more readily identify work boundaries (e.g., driveway edges, etc.), surface conditions, obstructions, etc.

FIGS. 1-3 illustrate right-side lighting device(s) 136 as being mounted upon an upper portion of a right sidewall 129 or other external surface of auger housing 126, with left-side lighting device(s) 140 being similarly mounted upon an upper portion of a left sidewall 130 of auger housing 126. With such a configuration, downward projection of light from the respective lighting devices 136, 140 to cover desired illumination areas 138, 142 may be readily achieved. However, it is to be understood that right-side lighting device(s) 136 and/or left-side lighting device(s) 140 may be mounted at any suitable location that allows for peripherally-directed, downwardly-projected illumination of the working surface. For example, in some embodiments, right-side lighting device(s) 136 and/or left-side lighting device(s) 140 may be mounted at lower respective portions of sidewalls 129, 130. In other embodiments, right-side lighting device(s) 136 and/or left-side lighting device(s) 140 may be mounted on a top surface 128 of auger housing 126.

One or more of lighting devices 132, 136, 140 may utilize any appropriate illumination device, such as one or more light emitting diodes (LEDs), one or more halogen bulbs, one or more incandescent bulbs, etc., and/or any combinations thereof. The lighting devices 132, 136, 140 may be chosen or configured to emit any desired lighting hue, such as white, amber, yellow, red, etc., and/or combinations thereof. A clear, transparent, or translucent housing made of a material such as, e.g., polycarbonate, may be utilized to protect the one or more illumination devices and/or may be colored to provide the desired hue. The housing may also incorporate a lens and/or reflector(s) for controlling and/or intensifying the projection of light from the respective illumination device.

Additionally, the wattage and/or amount of visible light emitted by the illumination device(s) may vary dependent upon the application, location, etc. For example, in one embodiment, a rear lighting device 132 may comprise two 5-watt LEDs. The lighting devices 132, 136, 140 may emit light across a range of possible amounts, e.g., 300-1000 lumens, providing for sufficient illumination of the respective illumination areas 134, 138, 142 in low-light environments. However, it is to be understood that other wattages and/or amounts of visible light are also possible in accordance with the present disclosure, and/or the respective lighting devices 132, 136, 140 may be configured to have adjustable amounts of visible light dependent upon various, user-selected settings. Furthermore, in some embodiments, the rear lighting device 132 may emit more visible light (e.g., about 500 lumens) than either of the respective right-side lighting device(s) 136 and/or left-side lighting device(s) 140, or vice versa.

Each lighting device 132, 136, 140 may be coupled to a respective cable 133, 137, 141, which may be configured to provide electrical power and/or control signals to lighting devices 132, 136, 140. In some embodiments, cables 133, 137, 141 may be coupled to an alternator (not shown) integrated with engine 116 so as to provide electricity to power respective lighting devices 132, 136, 140. In other, alternative embodiments, cables 133, 137, 141 may be coupled to at least one on-board starter battery (not shown) utilized for starting engine 116. The on-board starter battery may be, e.g., a lithium-ion battery, a lead acid battery, or any other suitable form of battery. In still further embodiments, cables 133, 137, 141 may be coupled to at least one dedicated battery utilized specifically to power the respective lighting devices 132, 136, 140. In such an embodiment, if each lighting device 132, 136, 140 includes its own dedicated battery and is capable of being controlled independently, cables 133, 137, 141 may be omitted. In instances where a starter battery and/or a dedicated battery (or batteries) are used to provide at least some power, the lighting devices 132, 136, 140 may be turned on even when the engine or other powerhead is not operating.

In addition to providing electrical power to lighting devices 132, 136, 140, in some embodiments, cables 133, 137, 141 may also be coupled to one or more switches and/or control circuitry so as to enable a user to control one or more aspects of illuminating the peripheral working area. For example, a single ON/OFF switch (not shown) may be located on any surface of snowthrower 110 (e.g., on control panel 121) so as to allow the user to selectively operate one or more of lighting devices 132, 136, 140. In other embodiments, each lighting device 132, 136, 140 may include its own on/off switch for selective activation of each lighting device 132, 136, 140. In still further embodiments, one or more control devices may be accessible to the user and coupled to lighting devices 132, 136, 140 so as to enable the user to control the intensity of illumination emitted by the lighting devices.

Alternatively and/or additionally, one or more of lighting devices 132, 136, 140 may be manually and/or automatically adjustable. That is, one or more angular orientations and/or areas of illumination may be adjustable so as to allow the user to set the desired illumination areas based on personal preference and/or situational needs. In some embodiments, such adjustment(s) may be manually completed by the user, such as by manually altering the angular orientation of one or more of lighting devices 132, 136, 140. In other embodiments, lighting devices 132, 136, 140 may be automatically adjusted via, for example, electric motors coupled to the respective lighting devices and capable of adjusting angular orientation, etc. Such automatic adjustments may be controlled by the user via any appropriate interface, such as one or more levers, knobs, etc., located on the snowthrower 110. Alternatively, in other embodiments, the one or more lighting devices 132, 136, 140 may be fixed in position such that the illumination area(s) do not vary.

In addition to the one or more downwardly-projecting lighting devices 132, 136, 140, snowthrower 110 may also include at least one forward-projecting lighting device 144 so as to project light ahead of the auger housing 126 and enable the user to see the work area in front of snowthrower 110. FIG. 1 shows forward-projecting lighting device 144 as being mounted on the top surface 128 of auger housing 126. However, it is to be understood that forward-projecting lighting device 144 may be mounted at any appropriate location on snowthrower 110 that allows for sufficient forward projection of light, such as on a front surface of control panel 121, on a portion of control frame 112, etc. Additionally, more than one forward-projecting lighting device 144 may be utilized. Similar to lighting devices 132, 136, 140, forward-projecting lighting device 144 may be powered by an alternator, a starter battery, one or more dedicated batteries, or any other suitable power source. Furthermore, in some embodiments, forward-projecting lighting device 144 may be individually controllable and/or adjustable, either manually or automatically.

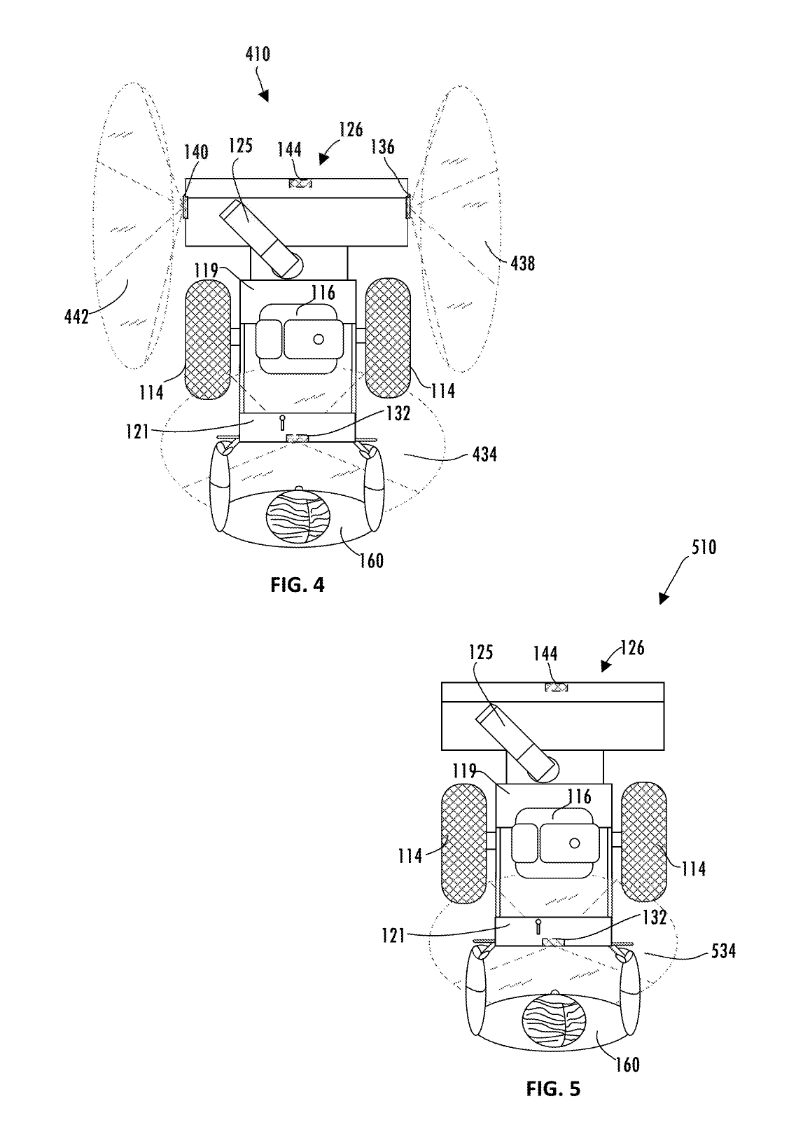

As noted above, the various illumination areas to the rear and/or sides of the snowthrower (or other form of outdoor power equipment) are not limited to those which are shown and described with respect to FIGS. 1-3. For example, referring to FIG. 4, a snowthrower 410 in accordance with another aspect of the disclosure is illustrated. Snowthrower 410 is configured similarly to snowthrower 110 and, thus, like components are represented by like reference numerals and will not be described further herein. However, unlike snowthrower 110, snowthrower 410 includes an expanded right-side illumination area 438 and an expanded left-side illumination area 442, with each respective illumination area extending both forward of auger housing 126 and to the rear of auger housing 126 relative to the direction of travel of snowthrower 410. In this way, the space illuminated and visible to the user in the right-side illumination area 438 and left-side illumination area 442 is significantly expanded as compared to that which is shown in FIGS. 1-3. Similarly, snowthrower 410 also includes an expanded rear operator area 434, wherein light is not only emitted toward an area between the rear of drive wheels 114 and the location where user 160 stands/walks, but is also emitted in a substantially downward direction toward at least some portions of at least one of the engine 116, motor box 119, and the drive wheels 114, as well as further rearward toward (and, potentially, behind and/or to the sides of) the user 160.

Referring to FIG. 5, a snowthrower 510 in accordance with yet another aspect of the disclosure is illustrated. Again, snowthrower 510 is configured similarly to snowthrower 110 and, thus, like components are represented by like reference numerals and will not be described further herein. Unlike snowthrower 410 described above with respect to FIG. 4, snowthrower 510 is configured such that there is no right-side illumination area or left-side illumination area and, thus, no corresponding right-side and left-side lighting devices. Rather, snowthrower 510 includes only the downwardly-projecting rear lighting device 132 emitting light in the direction of a rear operator area 534. As illustrated in FIG. 5, rear operator area 534 corresponds to light emitted in a substantially downward direction toward at least some portions of at least one of the engine 116, motor box 119, and the drive wheels 114, as well as further rearward toward (and, potentially, behind and/or to the sides of) the user 160. However, it is to be understood that rear operator area 534 may vary in size and/or location, and is not to be considered limited by that which is shown in FIG. 5.

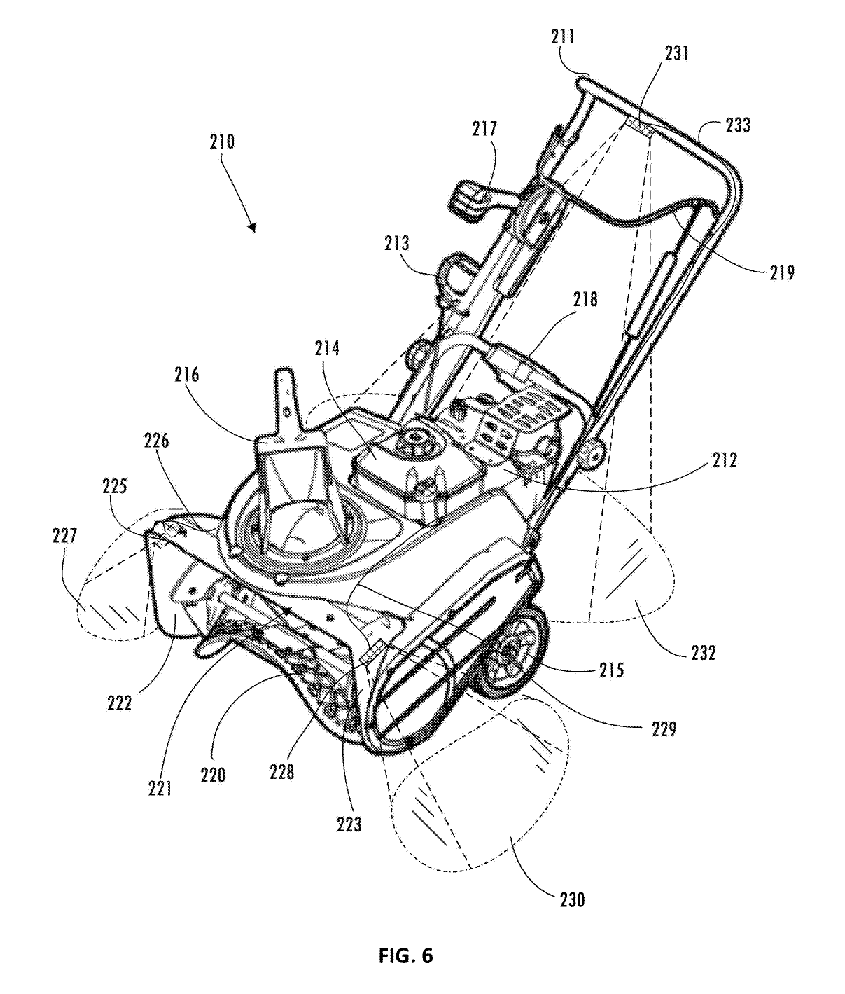

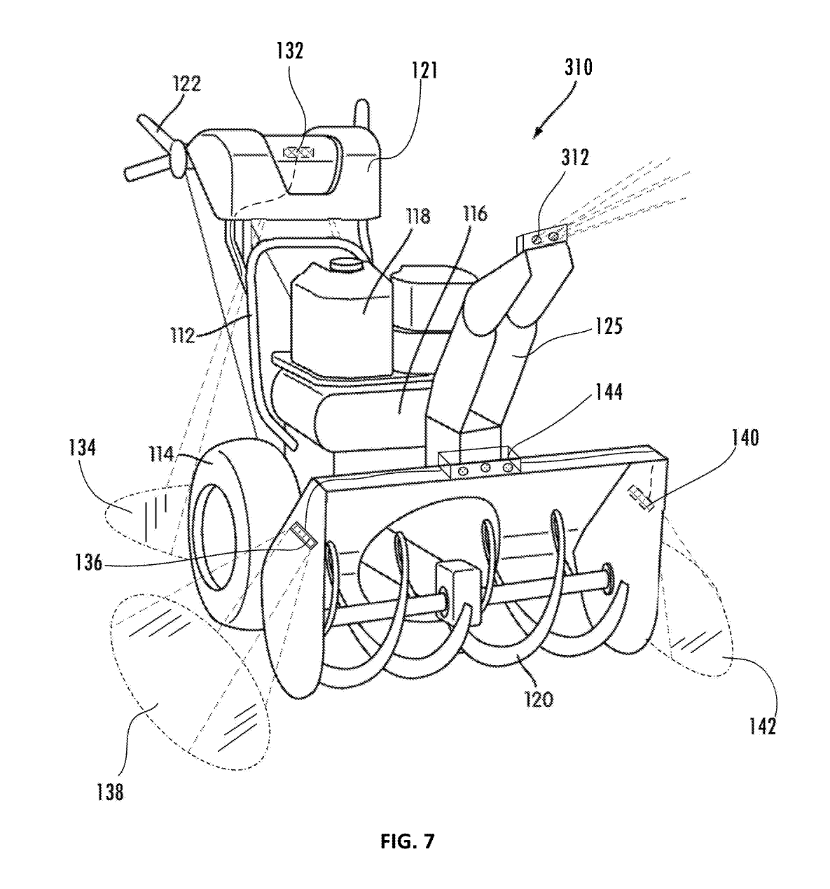

Referring now to FIG. 6, a single-stage snowthrower 210 in accordance with another aspect of the disclosure is illustrated. Snowthrower 210 comprises a grip handle 211, an engine 212, a fuel tank 214, and non-driven wheels 215. A starter pull cord 213 may be coupled to a rewind starter assembly (not shown) on engine 212 to enable a user to manually start engine 212. Alternatively and/or additionally, a starter battery housing 218 may be present to accept a starter battery (not shown) for utilization of an electric starting motor (not shown) to automatically start engine 212. While not shown in FIG. 6, in other embodiments, engine 212 may be replaced by any other suitable powerhead, such one or more electric motors.

Snowthrower 210 may further include a rotatable chute 216, which my either be manually rotated/adjusted by the user directly at chute 216, or rotated using chute rotation control lever 217 located adjacent a portion of handle 211. An impeller assembly 220 is rotatably housed within an impeller housing 221 and operably couplable to a PTO shaft of engine 212. When the user activates a drive mechanism 219, the impeller assembly 220 operably couples to the PTO shaft of engine 212, which imparts rotational motion on impeller assembly 220, thereby enabling impeller assembly 220 to both lift and expel snow, ice, or other materials from the ground surface through chute 216 and propel the snowthrower 210 in a forward motion along the ground surface.

Like snowthrower 110 described above with respect to FIGS. 1-3, single-stage snowthrower 210 also includes one or more downwardly-projecting lighting devices for illuminating the ground or other work surfaces at various locations around the periphery of snowthrower 210. Specifically, at least one rear lighting device 231 may be positioned at or near the rear of snowthrower 210 for substantially downward projection of light toward a rear operator area 232 at or near the operating area in which the user stands/walks when operating snowthrower 210. In addition to illuminating the ground or other working surface behind snowthrower 210, rear lighting device(s) 231 may also be configured to illuminate at least a portion of the engine 212, the starter battery housing 218, or other features located at or near the lower rear portions of snowthrower 210. While FIG. 6 shows rear lighting device(s) 231 as being mounted on an underside portion of handle 231, rear lighting device(s) 231 may be located at any appropriate location on snowthrower 210 which allows for downward-projecting illumination toward a desired operator working area 232. For example, rear lighting device(s) 231 may be mounted on a portion of starter battery housing 218, on another portion of handle 211, to the rear of engine 212, etc.

In addition to (or in lieu of) rear lighting device(s) 231, snowthrower 210 may include at least one right-side lighting device 225 and/or at least one left side lighting device 228. Similar to rear lighting device(s) 231, right-side lighting device(s) 225 and left-side lighting device(s) 228 may be configured for substantially downward projection of light toward respective right-side illumination area 227 and left-side illumination area 230. Right-side illumination area 227 is an area that includes a working surface substantially adjacent to a right side of impeller housing 221, while left-side illumination area 230 is an area that includes a working surface substantially adjacent to a left side of impeller housing 221, thereby enabling the user to better see the work area and more readily identify work boundaries (e.g., driveway edges, etc.), surface conditions, obstructions, etc., in low-light situations.

FIG. 6 illustrates right-side lighting device(s) 225 as being mounted upon an upper portion of a right sidewall 222 of impeller housing 221, with left-side lighting device(s) 228 being similarly mounted upon an upper portion of a left sidewall 223 of impeller housing 221. However, it is to be understood that right-side lighting device(s) 225 and/or left-side lighting device(s) 228 may be mounted at any suitable location that allows for peripherally-directed, downwardly-projected illumination of the working surface. For example, in some embodiments, right-side lighting device(s) 225 and/or left-side lighting device(s) 228 may be mounted at lower respective portion of sidewalls 222, 223. In other embodiments, right-side lighting device(s) 225 and/or left-side lighting device(s) 228 may be mounted elsewhere on an external surface of impeller housing 221, or even at a location on handle 211.

Similar to lighting devices 132, 136, 140 described above, lighting devices 225, 228, 231 may utilize any appropriate illumination type, such as one or more light emitting diodes (LEDs), one or more halogen bulbs, one or more incandescent bulbs, etc. The lighting devices 225, 228, 231 may emit any appropriate lighting hue, such as white, yellow, red, etc., and/or combinations thereof. Each lighting device 225, 228, 231 may be coupled to a respective cable 226, 229, 233, which may be configured to provide electrical power and/or control signals to lighting devices 225, 228, 231. In some embodiments, cables 226, 229, 233 may be coupled to an alternator (not shown) integrated with engine 212 so as to provide electricity to power respective lighting devices 225, 228, 231. In other, alternative embodiments, cables 226, 229, 233 may be coupled to at least one on-board starter battery (not shown) utilized for starting engine 212. In still further embodiments, cables 226, 229, 233 may be coupled to at least one dedicated battery utilized specifically to power the respective lighting devices 225, 228, 231.

In addition to providing electrical power to lighting devices 225, 228, 231, in some embodiments, cables 226, 229, 233 may also be coupled to one or more switches and/or control circuitry so as to enable a user to control one or more aspects of illuminating the peripheral working area. Alternatively and/or additionally, one or more of lighting devices 225, 228, 231 may be manually and/or automatically adjustable. That is, one or more angular orientations and/or areas of illumination may be adjustable so as to allow the user to set the desired illumination areas based on personal preference and/or situational needs. In some embodiments, such adjustment(s) may be manually completed by the user, such as by manually altering the angular orientation of one or more of lighting devices 225, 228, 231. In other embodiments, lighting devices 225, 228, 231 may be automatically adjusted via, for example, electric motors coupled to the respective lighting devices and capable of adjusting angular orientation, etc. Such automatic adjustments may be controlled by the user via any appropriate interface, such as one or more levers, knobs, etc., located on the snowthrower 210.

While not shown in FIG. 6, it is to be understood that snowthrower 210 may further include at least one forward-projecting lighting device so as to project light ahead of the impeller housing 221 and enable the user to see the work area in front of snowthrower 210. The forward-projecting lighting device may be located on the impeller housing 221, handle 211, or any other suitable location.

Next, referring to FIG. 7, a snowthrower 310 in accordance with another embodiment of the disclosure is illustrated. Structural parts of snowthrower 310 similar to those of snowthrower 110 described above will be denoted with like reference numerals, and, thus, detailed descriptions of those parts will not be repeated herein.

Snowthrower 310 may include at least one rear lighting device(s) 132, at least one right-side lighting device 136, and/or at least one left side lighting device 140, as described above with respect to FIGS. 1-3. Alternatively and/or additionally, snowthrower 310 may include a forward-projecting lighting device 144. However, in accordance with another embodiment of the disclosure, snowthrower 310 may also (or exclusively) include at least one additional lighting device in the form of a chute-mounted lighting device 312. Chute-mounted lighting device 312 may be configured to move in concert with rotational movement of chute 125, thereby providing illumination in the aimed expulsion direction of chute 125. In this way, chute-mounted lighting device 312 may enable the user (and others) to better see the adjacent areas where expelled snow is being distributed.

While not shown in FIG. 7, it is to be understood that chute-mounted lighting device 312 may be powered by any appropriate power source, such as an alternator, starter battery, dedicated battery, etc. Additionally, chute-mounted lighting device 312 may be configured and adjusted in substantially similar ways as lighting devices 132, 136, 140, 144 described above. Furthermore, while FIG. 7 shows chute-mounted lighting device 312 as being mounted on a top surface of chute 125, it is to be understood that chute-mounted lighting device 312 may be mounted on any side location of chute 125, and that more than one chute-mounted lighting device 312 may be utilized.

Additionally and/or alternatively, while not shown in FIGS. 1-7, auger housing 126 and/or impeller housing 221 may include one or more lighting devices configured to illuminate the interior of the respective auger housing 126 and/or impeller housing 221. In accordance with one aspect, the one or more lighting devices may be dedicated lighting device(s) coupled to an interior wall of the auger housing 126 and/or impeller housing 221. Alternatively, the respective right-side/left-side lighting devices 136, 140 and/or the right-side/left-side lighting devices 228, 231 may be configured to not only illuminate the right-side and left-side of the snowthrower, but to also provide illumination to the interior of the auger housing 126 and/or impeller housing 221. This could be achieved by, e.g., providing a clear window or opening along a wall at or near the right-side/left-side lighting devices 136, 140 and/or the right-side/left-side lighting devices 228, 231 so as to provide interior illumination. In this way, the operator would be able to readily observe snow and/or ice build-up or other blockages within the auger housing 126 and/or impeller housing 221 in low-light situations.

Utilizing one or more of the various non-forward projecting lights shown and described with respect to FIGS. 1-7, a user may better observe peripheral work surfaces and surrounding areas when operating the snowthrower. Furthermore, non-forward projecting lights may also increase visibility of the snowthrower to non-users, particularly those approaching the snowthrower from a side or from behind the machine. Such increased peripheral visibility by both the user and external non-users may be advantageous when operating snowthrowers in low-light conditions.

While the lighting systems shown and described with respect to FIGS. 1-7 are configured for use with various types of snowthrowers, it is to be understood that the disclosed lighting system for a rear operator area, right-side illumination area, and/or left-side illumination area may be modified for use on other forms of outdoor power equipment, such as, e.g., walk-behind lawnmowers, ride-on lawnmowers, aerators, blowers, sweepers, vacuums, tillers, etc.

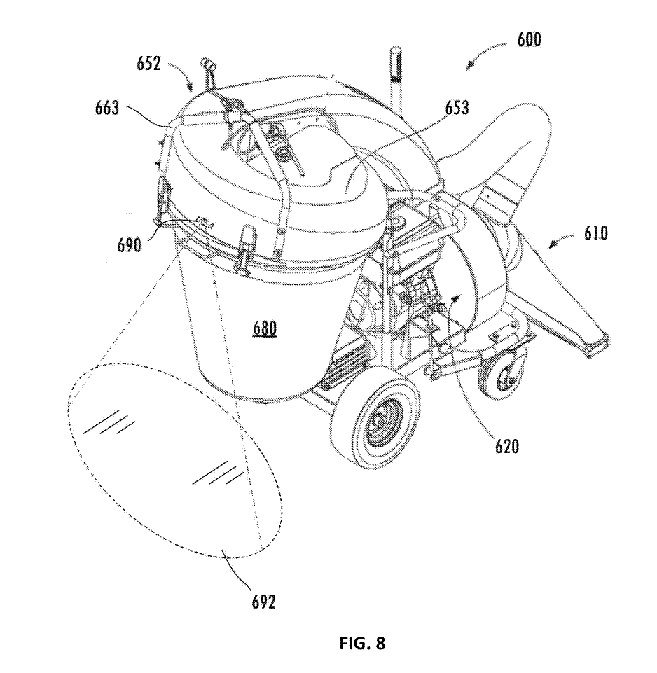

For example, referring to FIG. 8, a walk-behind, outdoor litter vacuum 600 in accordance with another aspect of the disclosure is shown. Similar to the snowthrowers 110, 210, 310, 410, and/or 510 described above, litter vacuums such as litter vacuum 600 are generally utilized in outdoor environments and may, in some instances, be used in low-light environments, where illumination of various areas on or around the litter vacuum 600 may be advantageous to the user. Litter vacuum 600 includes an input portion 610, a bagging portion 652, and a draft inducer 620 configured to draw debris through the input portion 610 and to the bagging portion 652. The draft inducer 620 may be driven by, e.g., an internal combustion engine or other powerhead, such as one or more electric motors. The bagging portion 652 includes a stationary hood 653 coupled to a removable bag retainer 680. Thus, as debris is drawn through the input portion 610, it is forcibly delivered through the hood 653 to a bag held within the bag retainer 680. Also included is a handlebar 663, which extends from a rear portion of hood 653 so as to allow for the user to control the speed and direction of the litter vacuum 600 as they walk behind litter vacuum 600.

As noted above, outdoor power equipment such as litter vacuum 600 may be utilized under varying conditions and environments, including low-light outdoor environments. Accordingly, in order to improve operation in such environments, litter vacuum 600 may further include one or more downwardly-projecting lighting devices for illuminating the ground or other work surfaces at various locations around the periphery of litter vacuum 600. For instance, at least one rear lighting device 690 may be positioned at or near the rear of litter vacuum 600 for at least partial downward projection of light toward a rear operator area 692, which may be defined as an area on the ground and/or other surfaces located to the rear of, the sides of, and/or below bagging portion 652. As is shown in FIG. 8, rear operator area 692 faces substantially toward the position where a user will typically stand/walk when operating the litter vacuum 600. Accordingly, rear lighting device(s) 690 may be configured to illuminate the ground or other working surface at or near the location of the user's feet, thereby allowing the user to better view the surface conditions over which the litter vacuum 600 travels. Furthermore, while not shown in FIG. 8, it is to be understood that litter vacuum 600 may include one or more lighting devices other than rear lighting device(s) 690, such as right-side/left-side lighting device(s), forward-projecting lighting device(s), etc. The lighting device (or devices) may be configured similarly to those described above with respect to FIGS. 1-7.

Accordingly, the downward-projecting lighting devices (and other lighting devices) described herein are not limited to use with snowthrowers, but may instead be implemented with many other forms of outdoor power equipment, including, e.g., litter vacuums (as shown in FIG. 8), sweepers, blowers, walk-behind lawnmowers, ride-on lawnmowers, aerators, tillers, etc.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A lighting system for outdoor power equipment, the lighting system comprising:
at least one downward-projecting lighting device coupled to the outdoor power equipment, the at least one downward-projecting lighting device configured to project light in at least a downward direction toward one or more of the following: a rear operator area, a right-side illumination area, and a left-side illumination area; and
at least one power source coupled to the at least one lighting device to provide electrical power to the at least one lighting device.

2. The lighting system of claim 1, wherein the outdoor power equipment is a snowthrower.

3. The lighting system of claim 2, wherein the snowthrower comprises an auger housing, and further wherein the at least one downward-projecting lighting device is coupled to an external surface of the auger housing.

4. The lighting system of claim 3, wherein the at least one downward-projecting lighting device comprises a first lighting device coupled to a right side surface of the auger housing and a second lighting device coupled to a left side of the auger housing.

5. The lighting system of claim 2, wherein the at least one downward projecting lighting device comprises a rear lighting device coupled to a control panel of the snowthrower.

6. The lighting system of claim 5, wherein the rear lighting device is coupled to an underside surface of the control panel.

7. The lighting system of claim 5, wherein the rear lighting device is configured to project light at least partially onto a rear portion of the snowthrower.

8. The lighting system of claim 1, wherein the at least one power source is at least one of a battery and an alternator operatively coupled to an engine of the outdoor power equipment.

9. The lighting system of claim 1, wherein the rear operator area comprises at least one of an area behind a pair of drive wheels of the outdoor power equipment, an area below a user control panel of the outdoor power equipment, and an area at which the user stands when operating the outdoor power equipment.

10. The lighting system of claim 1, wherein the at least one downward-projecting lighting device utilizes one or more light emitting diodes (LEDs), one or more halogen bulbs, or one or more incandescent bulbs.

11. The lighting system of claim 1, wherein the at least one downward-projecting lighting device is configured to be adjustable to alter the projected light toward at least one of the rear operator area, the right-side working area, or the left-side working area.

12. The lighting system of claim 1, wherein the at least one downward-projecting lighting device is configured to be fixed such that the projected light is emitted toward a fixed location relative to at least one of the rear operator area, the right-side working area, or the left-side working area.

13. The lighting system of claim 1, further comprising at least one additional lighting device coupled to a rotatable chute on the outdoor power equipment.

14. A snowthrower comprising:
a frame;
an operator interface coupled to the frame;
a power device coupled to the frame;
a rotatable tool at least partially surrounded by a rotatable tool housing, the rotatable tool operably coupled to the power device and configured to direct snow from a ground surface to a rotatable chute extending from the rotatable tool housing, wherein the rotatable chute is rotatable relative to the rotatable tool housing and configured to discharge snow from the snowthrower; and
at least one lighting device coupled to the snowthrower, wherein the at least one lighting device is configured to project light toward a rear operator area, wherein the rear operator area comprises at least one of an area on the ground surface located behind the frame, an area below the operator interface, and an area on the ground surface where a user is standing when operating the snowthrower.

15. The snowthrower of claim 14, wherein the at least one lighting device comprises a rear lighting device coupled to an underside surface of the operator interface of the snowthrower.

16. The snowthrower of claim 14, wherein the at least one lighting device comprises at least one light emitting diode (LED).

17. The snowthrower of claim 14, wherein the power device is one of an internal combustion engine and an electric motor.

18. A snowthrower comprising:
a frame;
a pair of drive wheels operably coupled to the frame;
an operator interface coupled to the frame, the operator interface comprising at least one hand grip and a control panel;
a rotatable tool at least partially surrounded by a rotatable tool housing, the rotatable tool configured to direct snow from a ground surface to a rotatable chute; and
at least one lighting device coupled to an underside surface of one of the frame and the operator interface, wherein the at least one lighting device is configured to project light toward a rear operator area, wherein the rear operator area comprises an area on the ground surface located to the rear of the frame and the pair of drive wheels.

19. The snowthrower of claim 18, wherein the at least one lighting device is coupled to an underside surface of the control panel.

20. The snowthrower of claim 18, wherein the at least one lighting device comprises at least one downwardly-projecting light emitting diode (LED).
